(19) United States
(12) Patent Application Publication
(10) Pub. No.: US 2010/0224467 A1
(43) Pub. Date: Sep. 9, 2010

(54) FIELD INTERCHANGEABLE AUXILLIARY SWITCH

(75) Inventors: Avijit Saha, Kolkata (IN); Kalpana Pasupuleti, Mumbai (IN); Kalyana Sundaram G, Bangalore (IN); Subramanion Nagarajan, Tamil Nadu (IN)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/396,737

(22) Filed: Mar. 3, 2009

(51) Int. Cl. H01H 1/00

(52) U.S. Cl. 200/290

(57) ABSTRACT

Disclosed is an electrical circuit making and breaking switch including a housing and a first electrical contact located in the housing. A block mechanism is located in the housing and includes a second electrical contact and a stopper disposed in mechanical communication with the second electrical contact. The stopper is positionable in the block mechanism, wherein a change in the position in the stopper results in a change in a contact position of the second electrical contact relative to the block mechanism. Further disclosed is a lateral block mechanism for an electrical circuit making and breaking switch. The lateral block mechanism includes two carrier assemblies and a connecting piece located between the two carrier assembles and secured thereto. An electrical contact is located at at least one of the two carrier assemblies.

### BACKGROUND OF THE INVENTION

The subject invention relates generally to circuit makers and breakers. More particularly, the subject invention relates to auxiliary switches for contactors.

Contactors are often provided with an auxiliary switch which typically includes a plurality of sets of electrical contacts for controlling auxiliary circuits such as operating coils of auxiliary devices. Auxiliary switches typically are configured depending on the auxiliary device with which the auxiliary switch is to be used as, for example, normally open-normally closed (NO-NC), normally closed-normally open (NC-NO), two normally open (2NO), or two normally closed (2NC). If a user changes from a device requiring, for example, an NC-NO auxiliary switch to, for example a device requiring a 2NO auxiliary switch, the user must purchase the desired 2NO auxiliary switch and replace the NC-NO auxiliary switch with it. This requires the user to incur cost to purchase additional auxiliary switches for the desired configurations. A cost-effective solution allowing the user to utilize a single auxiliary switch assembly for multiple device configurations would be well received in the art.

### BRIEF DESCRIPTION OF THE INVENTION

According to one aspect of the invention, an electrical circuit making and breaking switch includes a housing and a first electrical contact located in the housing. A block mechanism is located in the housing and includes a second electrical contact and a stopper disposed in mechanical communication with the second electrical contact. The stopper is positionable in the block mechanism, wherein a change in the position in the stopper results in a change in a contact position of the second electrical contact relative to the block mechanism.

According to another aspect of the invention, a lateral block mechanism for an electrical circuit making and breaking switch includes two carrier assemblies and a connecting piece located between the two carrier assembles and secured thereto. An electrical contact is located at at least one of the two carrier assemblies.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of an embodiment of an auxiliary switch;

FIG. 2 is a perspective view of a partially disassembled switch of FIG. 1;

FIG. 3 illustrates an embodiment of a cover assembly for the auxiliary switch of FIG. 1;

FIG. 4 illustrates an embodiment of a cover for the auxiliary switch of FIG. 1;

FIG. 5 illustrates a lateral block mechanism disposed in a cover for the auxiliary switch of FIG. 1;

FIG. 6 is a perspective view of a partially disassembled switch of FIG. 1;

FIG. 7 is a perspective view of an embodiment of a fixed contact for the auxiliary switch FIG. 6;

FIG. 8 illustrates an embodiment of a lateral block mechanism of an auxiliary switch;

FIG. 9 illustrates an embodiment of a carrier for the lateral block mechanism of FIG. 8;

FIG. 10 illustrates an embodiment of a moving contact for the auxiliary switch of FIG. 8;

FIG. 11 illustrates another embodiment of a lateral block mechanism of an auxiliary switch; and

FIG. 12 illustrates yet another embodiment of a lateral block mechanism of an auxiliary switch.

The detailed description explains embodiments of the invention, together with advantages and features, by way of example with reference to the drawings.

### DETAILED DESCRIPTION OF THE INVENTION

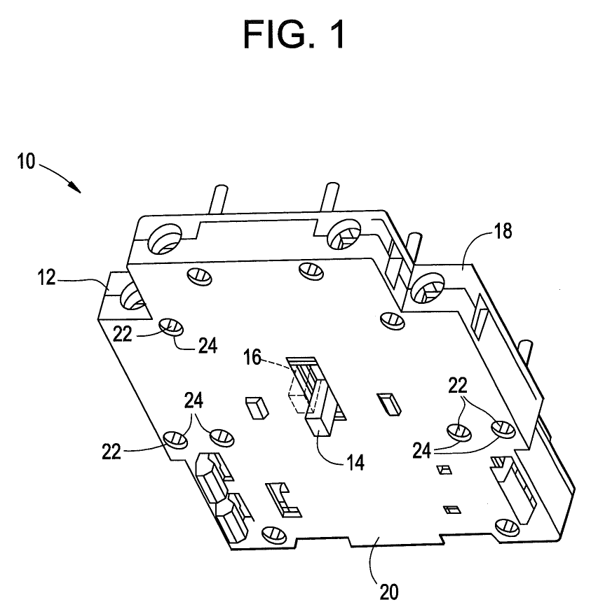

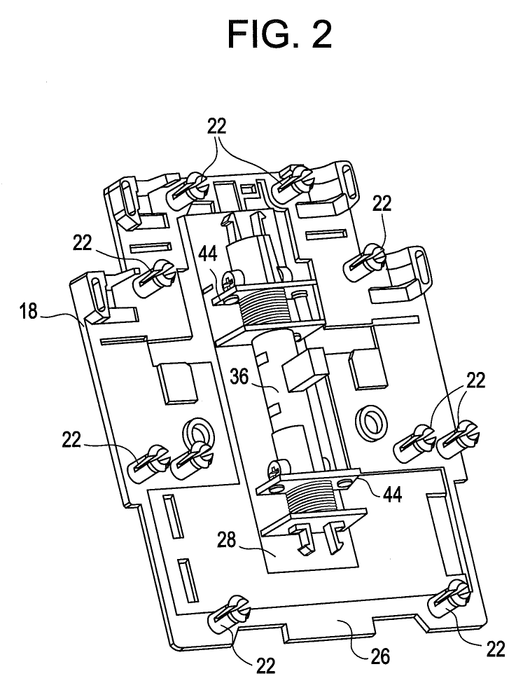

Shown in FIG. 1 is an embodiment of an auxiliary switch 10. The mechanism of the switch 10 is disposed in a housing 12 with an activator 14 extending through an activator opening 16 in the housing 12. In some embodiments, as illustrated in FIG. 1, the housing 12 includes a base 20 and a cover 18. The base 20 and the cover 18 may be assembled by, for example, a snap fit, or by a plurality of plastic rivets 22 (best shown in FIG. 2) extending from, for example, the cover 18 through a plurality of rivet holes 24 in the base 20. It is to be appreciated that other assembly configurations, for example, threaded fasteners (not shown) may be utilized to secure the cover 18 to the base 20.

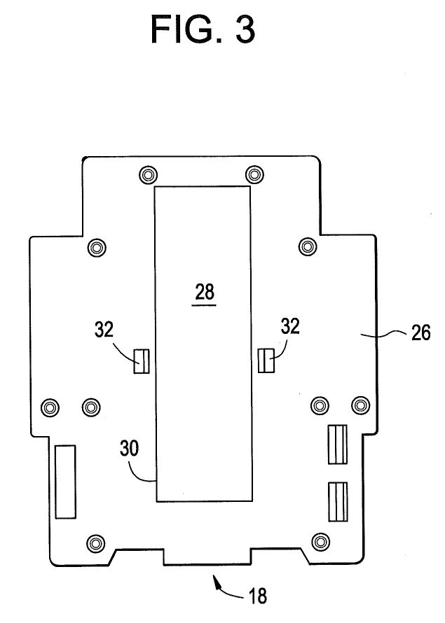

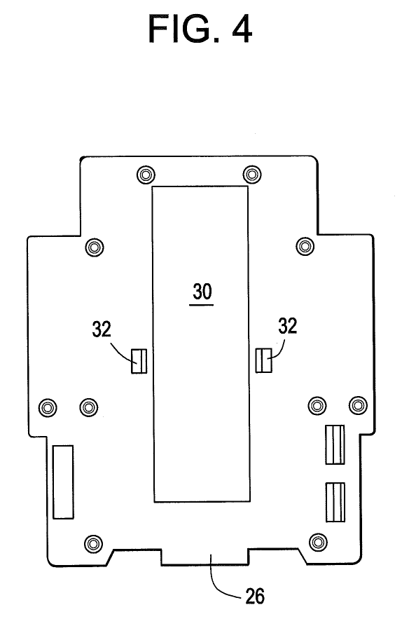

In some embodiments, as shown in FIG. 3, the cover 18 comprises an outer cover 26 and an inner cover 28. As best shown in FIG. 4, outer cover 26 includes a cover opening 30 and one or more snap features 32. Referring again to FIG. 3, the inner cover 28 is positioned over the cover opening 30, and may be held in position relative to the outer cover 26 via the one or more snap features 32. It is to be appreciated that the inner cover 28 may be secured to the outer cover 26 via other means, for example, one or more threaded fasteners (not shown), an adhesive, or an interference fit.

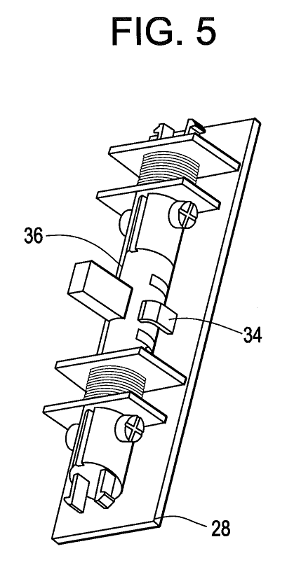

In some embodiments, as shown in FIG. 5, the inner cover 28 includes on or more guides 34 to position a lateral block mechanism 36 at the inner cover 28. The lateral block 36 may be assembled to the inner cover 28 via the one or more guides 34, and the inner cover 28 assembled to the outer cover 26 via the one or more snap features 32 to form a cover assembly 18.

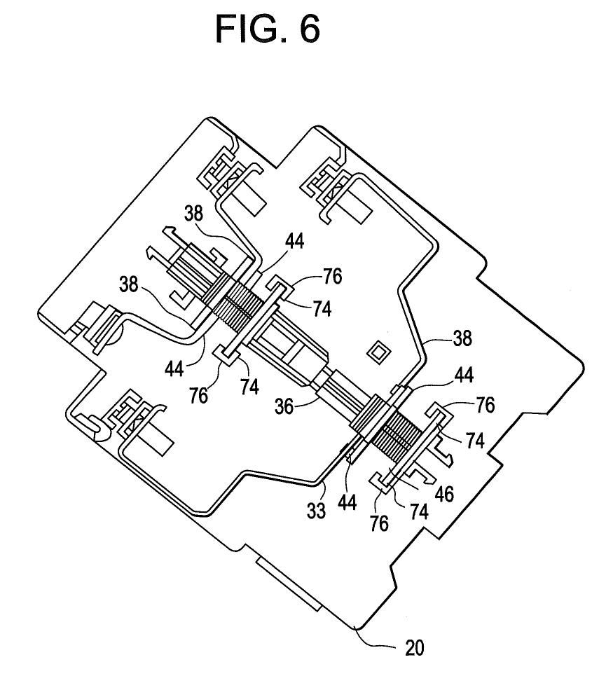

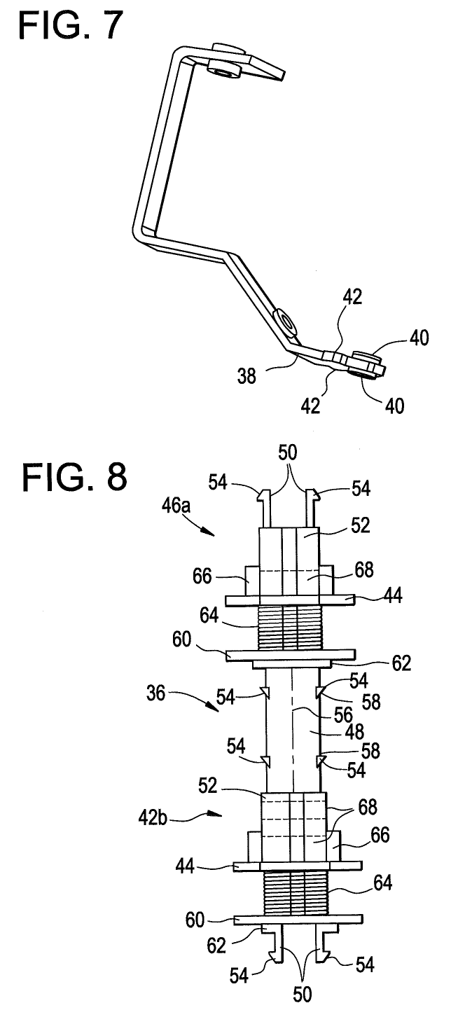

Referring now to FIG. 6, shown is a view of an embodiment of the switch 10 with the cover 18 removed. At least two electrically conductive fixed contacts 38 are disposed in the base 20. As shown in FIG. 7, in some embodiments each fixed contact 38 includes two contact tips 40, one contact tip 40 disposed on each contact face 42 of the fixed contact 38. Disposing two contact tips 40 at each fixed contact 38 aids in simple conversion of the switch 10 from NO to NC configuration and from NC to NO configuration. The lateral block mechanism 36 is slidably disposed, and includes two electrically conductive moving contacts 44. The lateral block mechanism 36 is connected to the activator 14 such that when the activator 14 translates in the activator opening 16, the moving contacts 44 slide in the inner cover 28 from a first position to a second position. The particular type of auxiliary switch 10 illustrated in FIG. 6 is a normally closed-normally closed (2-NC) meaning that the moving contacts 44 are normally engaged with the fixed contacts38 closing a circuit in the auxiliary switch 10 as shown in FIG. 6, and when the circuit needs to be opened, or when a fault is encountered, the moving contacts 44 move away from the fixed contacts 38 thus opening the circuit.

An embodiment of the lateral block mechanism 36 is shown in more detail in FIG. 8. The lateral block mechanism 36 comprises two carriers, 46a and 46b, and a connecting piece 48 disposed therebetween. Each carrier 46 has carrier legs 50 extending from each end of a carrier body 52. In the embodiment of FIG. 8, the carrier body 52 is substantially cylindrical and two carrier legs 50 extend from each end thereof. It is to be appreciated, however, that other shapes of carrier bodies 52 and other quantities of carrier legs 50, for example, three or four carrier legs 50, are contemplated within the present scope. As shown, each carrier leg 50 includes a carrier barb 54 which extends outwardly from the carrier leg 50 relative to a carrier axis 56. The carriers 46a and 46b are assembled into a single lateral block mechanism 36 by inserting the carrier barbs 54 at one and of each carrier 46 into corresponding carrier slots 58 in the connecting piece 48. In some embodiments, the carrier legs 50 of the two carriers 46 are inserted into the annular connecting piece 48 from opposite ends of the connecting piece 48, and when assembled, the carrier barbs 54 extend outwardly through the carrier slots 58 in the connecting piece 48.

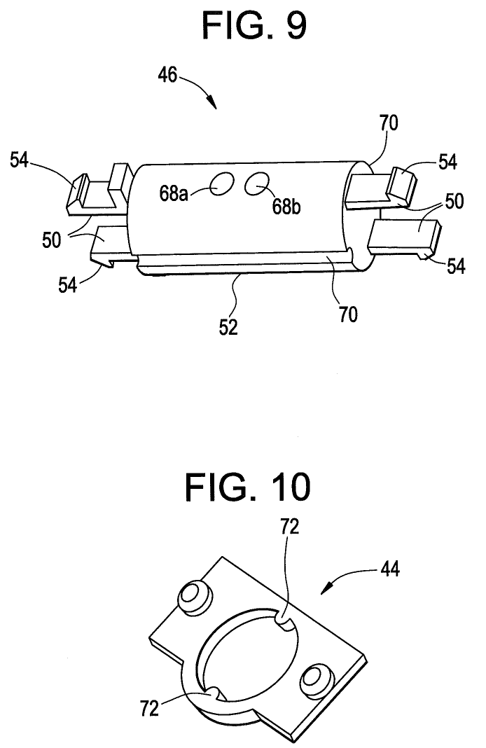

Each carrier 46 includes a pressure plate 60 fixed at first end 62 of the carrier body 52. One moving contact 44 is installed onto the carrier body 52, with a compression spring 64 located between the pressure plate 60 and the moving contact 44 on the carrier body 52. A position of the moving contact 44 on the carrier body 52 is determined by a location of a stopper 66 inserted through the carrier body 52. As best shown in FIG. 9, each carrier body 52 includes a plurality of stopper holes 68, for example two stopper holes 68, extending therethrough. The stopper 66 is inserted into the desired stopper hole, either 68a or 68b, such that the moving contact 44 is disposed between the compression spring 64 and the stopper 66. With the stopper 66 installed, the compression spring 64 exerts a force on the moving contact 44 thus securing the moving contact 44 between the compression spring 64 and the stopper 66. To change a position of the moving contact 44 on the carrier body 52, the stopper 66 is installed into one of the other stopper holes 68 of the plurality of stopper holes 68. Correspondingly, the force exerted by the compression spring 64 on the moving contact 44 will vary by changing the position of stopper 66.

In some embodiments, as shown in FIG. 9, the carrier body 52 includes one or more body guides 70, which in the embodiment of FIG. 9 are two channels disposed approximately 180 degrees from each other. The moving contact 44, as shown in FIG. 10, includes corresponding projections 72 which fit into the body guides 70 and guide the moving contact 44 between positions. It will be appreciated that other guide configurations may be utilized. For example, the projections 72 may be disposed on the carrier body 52 and the guides 70 may be disposed on the moving contact 44.

The lateral block mechanism 36 of FIG. 8 is configured for a 2-NC auxiliary switch 10. In this configuration, a first carrier 46a is installed into the connecting piece 48 such that the pressure plate 60 is nearer the connecting piece 48 than the moving contact 44. Further, in this embodiment, the stopper 66 is installed in the first carrier 46a in the stopper hole 68a nearest to the pressure plate 60. The second carrier 46b, on the other hand, is installed into the connecting piece 48 such that the moving contact 44 is nearer the connecting piece 48 than the pressure plate 60. In the second carrier 46b, the stopper 66 is installed in the stopper hole 68a nearest the pressure plate 60. Referring again to FIG. 6, ends 74 of each pressure plate 60 are fixed in a plurality of locating blocks 76 in the base 20 thus fixing a position of the pressure plates 60 in the base 20, and the moving contacts 44 in position contacting the fixed contacts 38.

The lateral block mechanism 36 can easily be restructured to accommodate other auxiliary switch 10 configurations, for example normally open-normally open (2NO), normally open-normally closed (NO-NC) and/or normally closed-normally open (NC-NO). To convert an auxiliary switch 10 from the 2NC configuration of FIG. 8 to a 2NO configuration, both carriers, 46a and 46b are inverted in the connecting piece 48. This is accomplished by inserting carrier 46a into the connecting piece 48 such that the moving contact 44 is nearer to the connecting piece 48 than the pressure plate 60 is, and by inserting carrier 46b in the connecting piece 48 such that the pressure plate 60 is nearer the connecting piece 48 than is the moving contact 44. Further, the stopper 66 is installed in each carrier 46 in the stopper holes 68 furthest from the pressure plate 60.

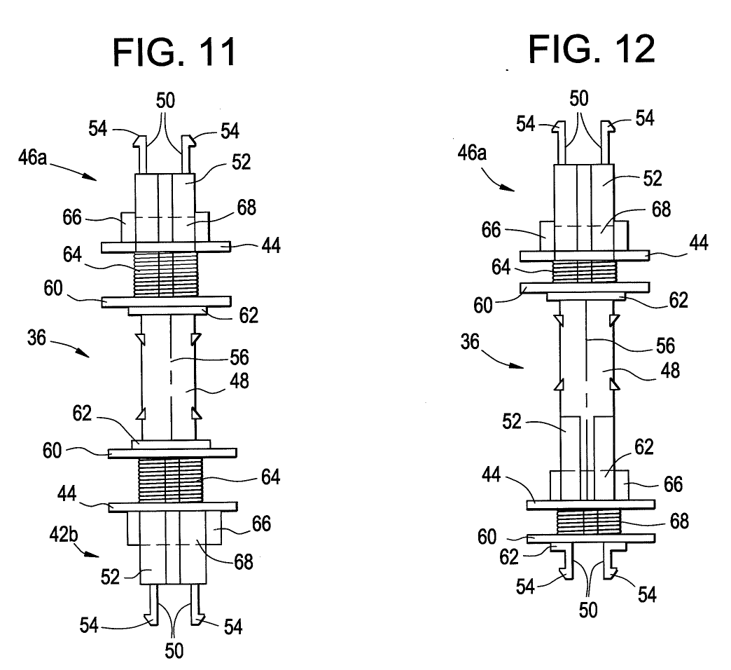

Further, as shown in FIG. 11, in some embodiments, the second carrier 46b can be inverted in the lateral block mechanism 36 by inserting the second carrier 46b into the connecting piece 48 such that the pressure plate 60 is nearer the connecting piece 48 than the moving contact 44. This will configure the auxiliary switch 10 to an NC and NO configuration. As shown in FIG. 12, the auxiliary switch 10 can be converted to an NO-NC configuration, by inverting only carrier 46a and leaving the position of carrier 46b unchanged. Stoppers 66 may be placed either in stopper hole 68 depending on position of the fixed contacts 38.

The changeability of the structure of the lateral block mechanism 36 by moving the stopper 66 between stopper holes 68a and 68b and/or by inverting one or both of the carriers 46a and 46b allows a user to simply reconfigure the auxiliary switch 10 to accommodate several different needs as described above. Further, the lateral block mechanism 36 is secured to the outer cover 28 which in turn is assembled to outer cover 26 via a snap fit. Thus reconfiguration of the auxiliary switch 10 is simple, and there is no need to replace the auxiliary switch 10 with a different one.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electrical circuit making and breaking switch comprising:
a housing;
a first electrical contact disposed in the housing; and
a block mechanism disposed in the housing, the block mechanism comprising:
a second electrical contact; and
a stopper disposed in mechanical communication with the second electrical contact and positionable in a first position and a second position in the block mechanism, wherein a change in the position in the stopper results in a change in a contact position of the second electrical contact relative to the block mechanism.

2. The switch of claim 1 wherein the block mechanism further comprises two carrier assemblies secured to a connecting piece disposed therebetween, each carrier assembly comprising a second electrical contact.

3. The switch of claim 2 wherein for each carrier assembly, when a first end of a carrier assembly is disposed in the connecting piece, the respective second electrical contact is in a different contact position than when a second end of the respective carrier assembly is disposed in the connecting piece.

4. The switch of claim 2 wherein each carrier assembly of the two carrier assemblies comprises:
a pressure plate affixed to a carrier body; and
a spring disposed between the pressure plate and the second electrical contact so as to bias the second electrical contact away from the pressure plate.

5. The switch of claim 4 wherein the compression spring is configured to secure second electrical contact between the spring and the stopper.

6. The switch of claim 4 wherein the pressure plate is disposed at a locating block in the housing thereby fixing the pressure plate in the housing.

7. The switch of claim 2 wherein each carrier assembly includes at least one carrier leg at least partially inserted in the connecting piece.

8. The switch of claim 7 wherein each carrier leg includes at least one barb inserted into a corresponding slot in the connecting piece to secure the carrier assembly to the connecting piece.

9. The switch of claim 1 wherein the lateral block mechanism comprises at least one stopper hole therethrough receptive of the stopper.

10. The switch of claim 9 wherein the at least one stopper hole comprises a first stopper hole and a second stopper hole, the first stopper hole utilized to position the second electrical contact in a first contact position and the second stopper hole utilized to position the second electrical contact in a second contact position.

11. The switch of claim 1 wherein the housing comprises three components secured together by snap-fit joints.

12. The switch of claim 1 wherein the first electrical contact comprises two contact tips disposed on opposing faces of the electrical contact.

13. A lateral block mechanism for an electrical circuit making and breaking switch comprising:
two carrier assemblies;
a connecting piece disposed between the two carrier assembles and secured thereto; and
an electrical contact disposed at at least one of the two carrier assemblies.

14. The lateral block mechanism of claim 13 wherein for each carrier assembly, when a first end the respective carrier assembly is disposed in the connecting piece, the respective electrical contact is in a different position than when a second end of the respective carrier assembly is disposed in the connecting piece.

15. The lateral block mechanism of claim 13 wherein each carrier assembly of the two carrier assemblies includes:
a pressure plate affixed to a carrier body; and
a spring disposed between the pressure plate and the electrical contact so as to bias the electrical contact away from the pressure plate.

16. The lateral block mechanism of claim 15 further comprising a stopper extending through the lateral block mechanism configured to secure the electrical contact between the spring and the stopper.

17. The lateral block mechanism of claim 16 further comprising at least one stopper hole therethrough receptive of the stopper.

18. The lateral block mechanism of claim 17 wherein the electrical contact is positionable in a first contact position and a second contact position relative to the lateral block mechanism by insertion of the stopper through a stopper hole of the at least one stopper hole.

19. The lateral block mechanism of claim 13 wherein each carrier assembly of the two carrier assemblies is at least partially inserted into the connecting piece.

20. The lateral block mechanism of claim 19 wherein each carrier assembly includes at least one carrier leg at least partially inserted into the connecting piece.

21. The lateral block mechanism of claim 20 wherein each carrier leg comprises at least one barb inserted into a corresponding slot in the connecting piece to secure the carrier assembly to the connecting piece.

22. The lateral block mechanism of claim 11 wherein each carrier assembly comprises at least one guide groove, each electrical contact including at least one complimentary projection insertable into the guide groove to guide the electrical contact during movement of the electrical contact along the carrier assembly.
